(19) United States
(12) Patent Application Publication
(10) Pub. No.: US 2026/0302563 A1
(43) Pub. Date: Oct. 1, 2026

(54) SECONDARY BATTERY AND METHOD OF MANUFACTURING SECONDARY BATTERY

(71) Applicant: SAMSUNG SDI CO., LTD., Yongin-si (KR)

(72) Inventors: Won Jun CHANG, Yongin-si (KR); Jae Dong YANG, Yongin-si (KR)

(21) Appl. No.: 19/320,776

(22) Filed: Sep. 5, 2025

(30) Foreign Application Priority Data
Mar. 27, 2025 (KR) 10-2025-0039210

(51) Int. Cl. H01M 50/586; H01M 10/0587; H01M 50/105; H01M 50/536; H01M 50/609

(52) U.S. Cl. CPC H01M 50/586; H01M 10/0587; H01M 50/105; H01M 50/536; H01M 50/609; H01M 2200/00; H01M 2220/20

(57) ABSTRACT

A secondary battery may include an electrode assembly, an electrolyte around the electrode assembly, and a battery case in which the electrode assembly and the electrolyte are disposed. The electrode assembly may include a first electrode plate having a first electrode active material layer on at least one surface thereof and a first non-coated portion having a surface accepting an insulating material, a second electrode plate having a second electrode active material layer on at least one surface thereof and a second non-coated portion having a surface accepting an insulating material, and a separator disposed between the first electrode plate and the second electrode plate. An insulating layer having insulating particles is disposed on at least one of the first non-coated portion, not having a first electrode active material, or the second non-coated portion, not having a second electrode active material.

### CROSS-REFERENCE TO THE RELATED APPLICATION

The present application claims priority to and the benefit of Korean Patent Application No. 10-2025-0039210, filed on Mar. 27, 2025, in the Korean Intellectual Property Office, the entire disclosure of which is incorporated herein by reference.

### BACKGROUND

### 1. Field

Aspects of some embodiments of the present disclosure relate to a secondary battery and a method of manufacturing a secondary battery.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Aspects of some embodiments of the present disclosure provide a secondary battery, which may introduce an insulating layer without requiring a separate coating process, or a like process, if applying the insulating layer to a surface of an area of a non-coated portion of the secondary battery, on which an electrode active material is not applied, and a method of manufacturing the same or a similar secondary battery.

These and other aspects and features of the present disclosure will be described in or will be apparent from the following description of embodiments of the present disclosure.

A secondary battery according to some embodiments of the present disclosure may include an electrode assembly, an electrolyte, and a battery case in which the electrode assembly and the electrolyte may be disposed. The electrode assembly may include a first electrode plate having a first electrode active material layer on at least one surface thereof and a first non-coated portion having a surface accepting an insulating material, a second electrode plate having a second electrode active material layer on at least one surface thereof and a second non-coated portion having a surface accepting an insulating material, and a separator disposed between the first electrode plate and the second electrode plate. An insulating coating layer having insulating particles may be disposed on at least one of the first non-coated portion, of which a first electrode active material may be not applied on the first electrode plate, or the second non-coated portion, of which a second electrode active material may be not applied on the second electrode plate. The insulating particles of the insulating coating layer may be provided to the first non-coated portion or to the second non-coated portion by attaching insulating particles of the electrolyte to the surface of the first non-coated portion or the second non-coated portion.

In some embodiments, the insulating particles of the insulating coating layer may be a same type of particle as at least one insulating particle of the insulating particles of the electrolyte.

In some embodiments, the insulating particles of the insulating coating layer may be ceramic particles.

In some embodiments, the ceramic particles may include boehmite.

In some embodiments, the insulating particles of the insulating coating layer may be non-uniformly dispersed on the insulating coating layer.

In some embodiments, a particle size of each of the insulating particles of the insulating coating layer may be from about 150 nm to about 200 nm based on D50.

In some embodiments, insulating particles that may be identical to insulating particles disposed on the insulating coating layer may be dispersed on a surface of at least one of the first electrode active material layer or the second electrode active material layer of the electrode assembly.

In some embodiments, a minimum distance between the insulating particles disposed on the insulating coating layer may be narrower than a minimum distance between the insulating particles disposed on at least one of the first electrode active material layer or the second electrode active material layer.

In some embodiments, a density at which the insulating particles disposed on the insulating coating layer may be dispersed may be greater than a density at which the insulating particles disposed on at least one of the first electrode active material layer or the second electrode active material layer may be dispersed.

In some embodiments, the battery case may include a first case, a second case bonded to the first case, and a recess configured to accept the electrode assembly. The secondary battery may be configured as a pouch-type secondary battery.

A method of manufacturing a secondary battery according to some embodiments of the present disclosure may include providing an electrode assembly, in which an electrode lead tab may be welded inside a battery case and injecting an electrolyte, having or more insulating particles, into the battery case. The injecting may include dispersing the insulating particles of the electrolyte so that the one or more insulating particles may be attached on a surface of a first non-coated portion on which a first electrode active material layer may be not formed and on a surface of a second non-coated portion on which a second electrode active material layer may be not formed.

In some embodiments the method may further include dispersing and attaching the one or more insulating particles within the electrolyte on the first non-coated portion and the second non-coated portion via a chromatographic phenomenon.

In some embodiments, the injecting may further include dispersing one or more ceramic particles as the one or more insulating particles within the electrolyte.

In some embodiments, the injecting may further include dispersing insulating particles having a concentration from about 5 wt % to about 20 wt % within the electrolyte.

In some embodiments, the dispersing may further include dispersing ceramic particles within the electrolyte before injecting the electrolyte into the battery case.

In some embodiments, the dispersing the ceramic particles may further include mixing the electrolyte at a speed of about 150 rpm to about 250 rpm for about 1 minute to about 5 minutes.

In some embodiments the method may further include dispersing the one or more insulating particles on a surface of at least one of the first electrode active material layer or the second electrode active material layer, so that the insulating particles of the electrolyte may be attached on surfaces of the first non-coated portion or the second non-coated portion within the electrode assembly.

In some embodiments the method may further include disposing the one or more insulating particles on a surface of the first non-coated portion and a surface of the second non-coated portion at a greater density than a density of which the insulating particles may be dispersed on a surface of at least one of the first electrode active material layer or the second electrode active material layer.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates a schematic exploded perspective view of a secondary battery according to some embodiments of the present disclosure.

FIG. 2 illustrates a partial exploded perspective view of an electrode assembly disposed in the secondary battery of FIG. 1 according to some embodiments of the present disclosure.

FIG. 3 illustrates a schematic partial exploded perspective view of a first electrode plate, a second electrode plate, and a surface of a separator disposed between the first electrode plate and the second electrode plate of an electrode assembly according to some embodiments of the present disclosure.

FIG. 4 illustrates a schematic partial exploded perspective view of a first electrode plate, a second electrode plate, and a surface of a separator disposed between the first electrode plate and the second electrode plate of an electrode assembly according to related art.

FIG. 5 illustrates a schematic partial exploded perspective view of a first electrode plate, a second electrode plate, and a surface of a separator disposed between the first electrode plate and the second electrode plate of an electrode assembly according to some embodiments of the present disclosure.

FIG. 6 illustrates a flowchart of a method of manufacturing a secondary battery according to some embodiments of the present disclosure.

FIGS. 7a to 7c illustrate schematic graphs showing a temperature change with respect to time and a voltage change with respect to time for a secondary battery according to some embodiments of the present disclosure.

FIGS. 8a and 8b illustrate perspective views of a battery pack including an exemplary secondary battery according to some embodiments of the present disclosure.

FIG. 9a illustrates a perspective view of a vehicle including an exemplary battery pack according to some embodiments of the present disclosure.

FIG. 9b illustrates a side view of a vehicle including an exemplary battery pack according to some embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value greater than or equal to 1.0 and a maximum value less than or equal to 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a). References to two compared elements, features, etc. as being “the same” may mean that they are “substantially the same”.

Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be arranged in contact with the upper (or lower) surface of the element, and another element may also be interposed between the element and the arbitrary element located on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for describing embodiments of the present disclosure and are not intended to limit the present disclosure.

Below, a secondary battery according to some embodiments is described as a pouch-type secondary battery, but this is only for convenience of description, and configurations of secondary batteries that are the same or are similar may be applied to a cylindrical secondary battery, a square secondary battery, etc.

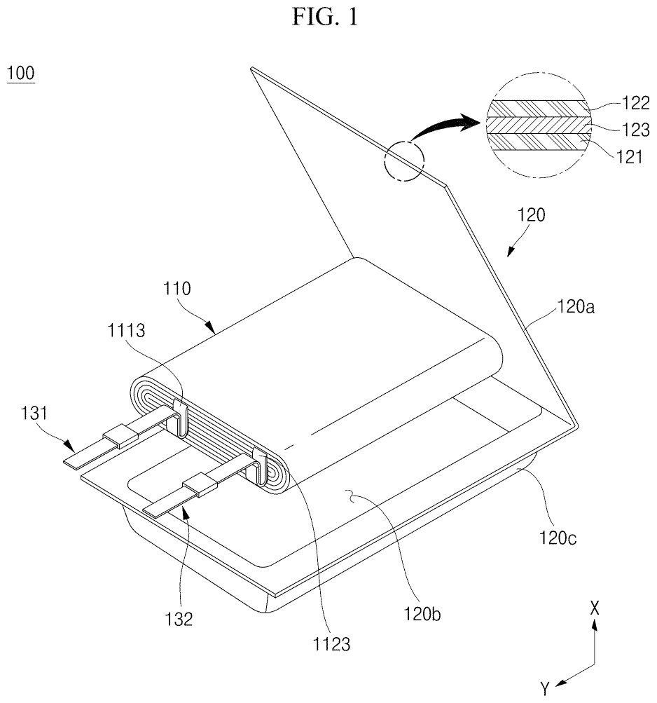

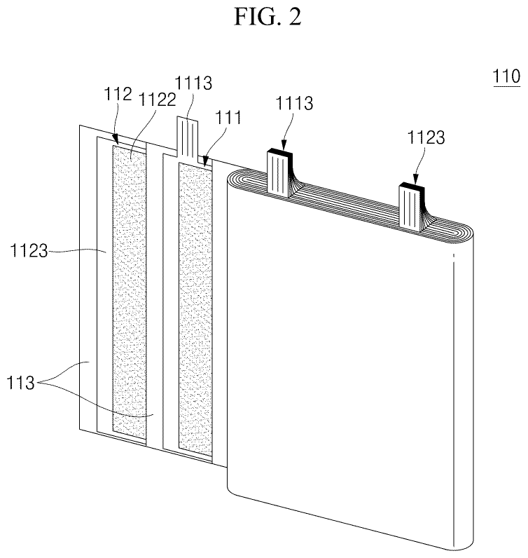

FIG. 1 illustrates a schematic exploded perspective view of a secondary battery 100 according to some embodiments of the present disclosure. FIG. 2 illustrates a partial exploded perspective view of an electrode assembly 110 disposed in the secondary battery 100 of FIG. 1 according to some embodiments of the present disclosure. As illustrated in FIG. 1 and FIG. 2, the secondary battery 100 may generally include an electrode assembly 110 and a battery case 120 containing the electrode assembly 110.

The electrode assembly 110 may be provided by winding or stacking a first electrode plate 111, a second electrode plate 112, and a separator 113 disposed between the first electrode plate 111 and the second electrode plate 112, each of which has a thin plate or film shape. If the electrode assembly 110 is a wound stack, a winding axis may be parallel to a longitudinal direction of the case 120. In some embodiments, the electrode assembly 110 may be provided in a stack type rather than the winding type. The electrode assembly 110 may be a Z-stack electrode assembly in which a first electrode plate and a second electrode plate are inserted on both sides of a separator 113, which is folded in the form of a Z-stack. The electrode assembly 110 may be accommodated inside the case 120 by stacking one or more electrode assemblies 110 adjacent to each other. In some embodiments, the first electrode plate 111 of the electrode assembly 110 may serve as a negative electrode, and the second electrode plate 112 may serve as a positive electrode, and vice versa.

The first electrode plate 111 may be made of metal foil such as copper, a copper alloy, nickel, or a nickel alloy and may include a first electrode active material layer 1112 on which a first electrode active material (e.g., a negative electrode active material) such as graphite or carbon is applied to at least one surface. In some embodiments, the first electrode plate may include a plurality of first non-coated portions 1113 as areas on which the first electrode active material is not applied. In some embodiments, the first non-coated portion 1113 may be formed to protrude in advance from one side of the first electrode plate 111 by notching or cutting, or the first non-coated portion 1113 may protrude further to one side than the separator 113 without a separate cutting. In some embodiments, a first electrode lead tab 131, may be bonded to the first non-coated portion 1113. The first electrode lead tab 131, which transmits electrons collected in the first electrode plate to an external circuit may be provided as a nickel plate, may be bonded to the first non-coated portion.

The second electrode plate 112 may include a second electrode active material layer 1122 which is provided as metal foil such as aluminum or an aluminum alloy and on which a second electrode active material (e.g., a positive electrode active material) such as transition metal oxide is applied to at least one surface thereof. In some embodiments, the second electrode plate may include a plurality of second non-coated portions 1123 as areas on which the second electrode active material is not applied. In some embodiments, the second non-coated portion 1123 may be formed to protrude in advance from one side of the first electrode plate 111 by notching or cutting, or the second non-coated portion 1123 may protrude further to one side than the separator 113 without a separate cutting.

The first non-coated portion 1113 of the first electrode plate 111 and the second non-coated portion 1123 of the second electrode plate 112 may be spaced apart from each other on one end of the electrode assembly 110.

In some embodiments, a second electrode lead tab 132 may be coupled to the second non-coated portion 1123. A second electrode lead tab 132 (which transmits, to an external circuit, electrons collected in the second electrode plate) may be provided as a nickel plate and/or may be bonded to the second non-coated portion.

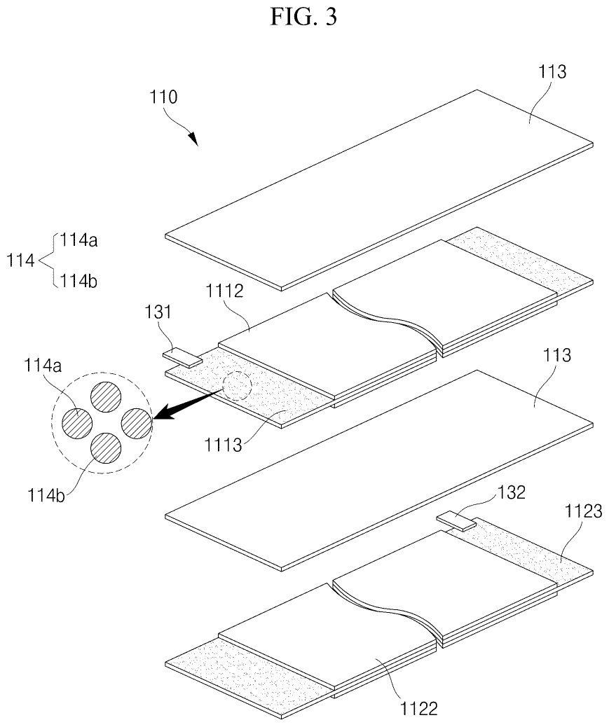

FIG. 3 illustrates a schematic exploded perspective view of an electrode assembly in the secondary battery according to some embodiments of the present disclosure. Referring to FIG. 3, the first electrode lead tab 131 may be bonded to the plurality of first non-coated portions 1113 on which the first electrode active material layer is not applied, and the second electrode lead tab 132 may be bonded to the plurality of second non-coated portions 1123 on which the second electrode active material layer is not applied. The first electrode lead tab may be bonded to the outermost side of the first non-coated portion, and the second electrode lead tab may be bonded to the outermost side of the second non-coated portion, but the positions to which the first and second electrode lead tabs 131 and 132 are attached are not limited thereto.

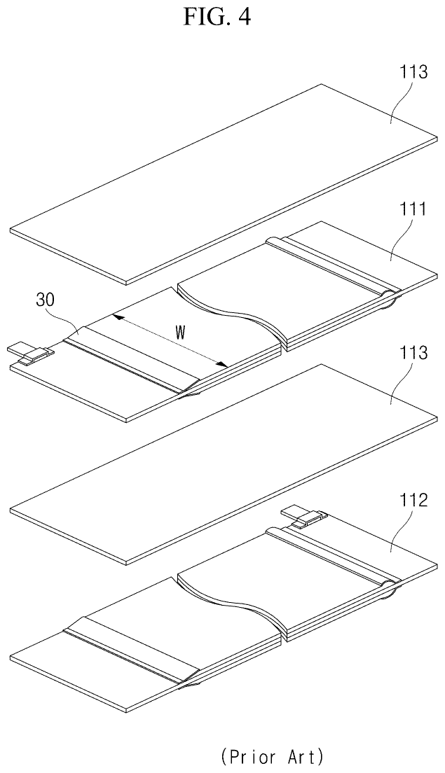

FIG. 4 illustrates a schematic partial exploded perspective view of a first electrode plate, a second electrode plate, and a surface of a separator disposed between the first electrode plate and the second electrode plate of an electrode assembly according to related art. The first and second non-coated portions may correspond to vulnerable portions at which short circuit between the positive electrode and the negative electrode occurs, and an insulating layer coating technology may be applied to protect the vulnerable portions. Referring to FIG. 4, an insulating tape 30 configured to cover at least one end of both ends of the active material layer for the negative or positive electrode plate may be provided. A shape and a material of the insulating tape 30 are not limited to what is described herein, but the insulating tape 30 may include an adhesive layer and an insulating film attached to one side of the adhesive layer to cover at least one end of the active material layer with a width equal to a width w of the active material layer. The adhesive layer may be made of an ethylene-acrylic ester copolymer, a rubber-based adhesive, an ethylene vinyl acetate copolymer, etc., and the insulating film may be made of polypropylene, polyethylene terephthalate, polyethylene naphthalate, etc.

However, when introducing the insulating film of FIG. 4, it may be inconvenient to additionally perform a coating process for attaching an adhesive layer and a film attached thereon. Particularly, in the case of polymer-based materials, thermal stability is low, and thus, deformation due to heat generated if passing through/colliding with a pouch-shaped secondary battery may occur, and a characteristic effective to prevent a short circuit may be insufficient.

In FIG. 3, in the electrode assembly 110 of the secondary battery 100 according to some embodiments, a plurality of insulating particles 114a and 114b may be attached to at least a portion of surfaces of the first and second non-coated portions 1113 and 1123 of the electrode assembly 110. Because the plurality of insulating particles 114a and 114b are densely distributed on surfaces of the first and second non-coated portions 1113 and 1123, a similar or a same result as that of coating an area of the non-coated portion may be obtained. A process of attaching the plurality of insulating particles 114a and 114b to the surfaces of the first and second non-coated portions 1113 and 1123 to form the insulating layer may be performed during a process of injecting an electrolyte without a separate insulating coating process. In the process of injecting the electrolyte into the battery case, the insulating particles dispersed in the electrolyte while being impregnated into an inside of the electrode assembly may be densely dispersed in the first and second non-coated portions and then may be attached to the surfaces of the first and second non-coated portions. As a result, the plurality of insulating particles 114a and 114b in the insulating coating layer 114 formed by the insulating particles attached to the first and second non-coated portions 1113 and 1123 may be substantially the same as or identical to the insulating particles contained in the electrolyte.

The insulating particles may be applied without limitation as long as the insulating particles exhibit insulating properties, but it may be appropriate to select ceramic particles that contain at least one of boehmite or alumina. The ceramic particles described above may have excellent thermal properties in spite of having a small amount of moisture to minimize thermal contraction and may prevent the separator from being thermally deformed when a temperature inside the battery rises rapidly due to a short circuit of the secondary battery, thereby improving safety of the secondary battery.

It is appropriate that a particle size of the ceramic particles ranges from about 150 nm to about 200 nm based on D50, which may refer to a median particle size where 50% of the particles by volume [or weight] are smaller than this median particle size, and 50% of the particles are larger. In the particle size ranging from about 150 nm to about 200 nm based on D50, ceramic dispersion characteristics in the electrolyte may be realized, and sufficient insulating characteristics (after the attachment of insulating particles on a surface of a non-coated portion of an electrode assembly) may be realized.

The electrolyte according to some embodiments may include a non-aqueous organic solvent, lithium salt, and insulating particles.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

The lithium salt may be, for example, lithium hexafluorophosphate (LiPF₆), lithium trifluoromethanesulfonate (LiTFSI), lithium bis(fluorosulfonyl)imide (LiFSI), etc.

The insulating particles contained in the electrolyte may be applied without limitation as long as the insulating particles exhibit insulating properties, but it may be appropriate to select ceramic particles that contain at least one of boehmite or alumina. The ceramic particles described above may have excellent thermal properties in spite of having a small amount of moisture to minimize thermal contraction and may prevent the separator from being thermally deformed even when a temperature inside the battery rises rapidly due to a short circuit of the secondary battery, thereby improving safety of the secondary battery.

It is appropriate that a particle size of the ceramic particles ranges from about 150 nm to about 200 nm based on D50. In the particle size ranging from about 150 nm to about 200 nm based on D50, ceramic dispersion characteristics in the electrolyte may be realized, and sufficient insulating characteristics (after the attachment of insulating particles on a surface of a non-coated portion of an electrode assembly) may be realized.

The ceramic particles contained in the electrolyte may substantially overlap the ceramic particles attached on the surface of the non-coated portion of the electrode assembly.

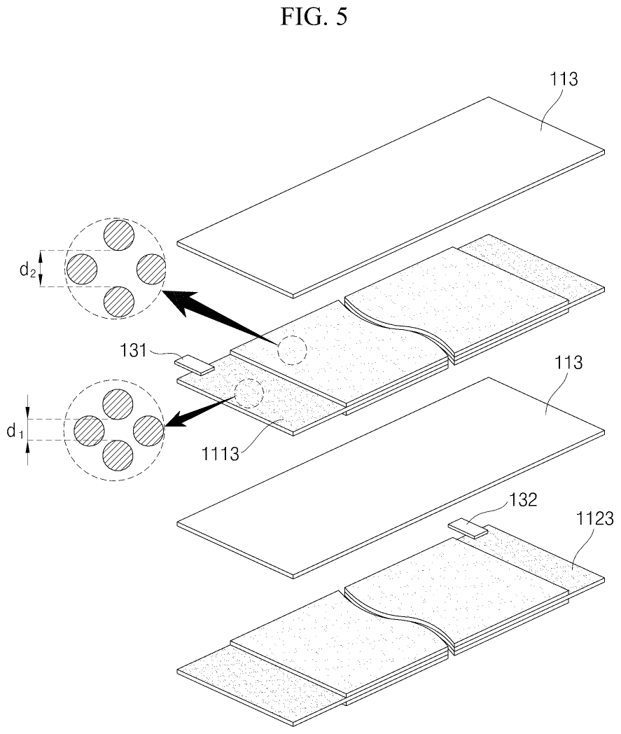

FIG. 5 illustrates an electrode assembly of a secondary battery according to some embodiments of the present disclosure. For understanding of the present disclosure, the same reference numerals corresponding to those of the electrode assembly of FIG. 3 will be used. Referring to FIG. 5, insulating particles 114a and 114b attached to first and second non-coated portions 1113 and 1123 may also be dispersed and may be attached to surfaces of first and second electrode active material layers 1112 and 1122. The insulating particles forming an insulating layer on each of the surfaces of the first and second non-coated portions may be attached to the surfaces of the first and second non-coated portions due to an occurrence of a separation phenomenon between ceramic particles and an electrolyte during a process of impregnating the electrolyte into the electrode assembly. In some embodiments, the insulating particles in the electrolyte may form an insulating layer on surfaces of the first and second non-coated portions and may also be attached to the surfaces of first and second electrode active material layers. In some embodiments, a minimum distance d1 between the insulating particles 114a and 114b disposed on an insulating coating layer 114 may be less than a minimum distance d2 between the insulating particles 115a and 115b disposed on a surface of at least one of the first electrode active material layer 1112 or the second electrode active material layer 1122. In some embodiments, a density, at which the insulating particles disposed on the insulating coating layer 114 are dispersed on the surface of the insulating coating layer 114 (i.e., the number of insulating particles per unit area) may be greater than a density at which the insulating particles disposed on the first electrode active material layer 1112 and the second electrode active material layer 1122 are dispersed on the surface of the first electrode active material layer 1112 and the second electrode active material layer 1122. This may mean that insulating particles are densely attached to the surfaces of the non-coated portions if a separation between the ceramic and the remaining electrolyte (such as the non-aqueous organic solvent) occurs as the electrolyte is impregnated into the electrode assembly.

The electrode assembly 110 may be accommodated in a battery case 120 together with the electrolyte. A plurality of first non-coated portions 1113 of a first electrode plate may be welded and connected to a first electrode lead tab 131 and then may be disposed within the battery case, and a plurality of second non-coated portions 1123 of a second electrode plate may be welded and connected to a second electrode lead tab 132 and then may be disposed within the battery case.

The first electrode lead tab 131 and the second electrode lead tab 132 may extend from an inside to an outside of the case 120. The first electrode lead tab 131 and the second electrode lead tab 132 may also be spaced apart from each other, similarly to how the first non-coated portion 1113 and the second non-coated portion 1123 are spaced apart from each other. Further, in some embodiments, the first electrode lead tab 131 may include metal foil such as copper, a copper alloy, nickel, or a nickel alloy, and the second electrode lead tab 132 may include metal foil such as aluminum or an aluminum alloy.

The battery case 120 may accommodate the electrode assembly 110 together with the electrolyte described above. The battery case 120 may include or be referred to as a housing, an exterior, a laminate exterior, or a pouch. The battery case 120 may include a first case 120a that is approximately flat and a second case 120b that is bonded to the first case 120a and that includes a recess 120c for positioning the electrode assembly 110 therein. A sealing area may be provided around the recess 120c of the second case 120b, and, thus, a pouch-type secondary battery may be realized from the bonding between the first case and the second case at the sealing area.

The case 120 may be provided as a multilayer structure including a first insulating layer 121, a second insulating layer 122, and a metal layer 123 between the first and second insulating layers. In addition to the first and second insulating layers and the metal layer, various adhesive layers or functional layers may be added. The first insulating layer 121 may define an inner surface of the battery case and may be provided with a material having insulating and thermal adhesive properties. In some embodiments, the first insulating layer 121 may be provided on one surface of the metal layer 123 to define an inner surface facing the electrode assembly. The first insulating layer 121 may include polypropylene (PP), cast polypropylene (CPP) that does not react with the electrolyte, or a similar compound. The case 120 may be sealed by accommodating the electrode assembly in the recess 120c of the second case 120b and bonding the first case 120a to the second case 120b through the process of bonding the first insulating layers 121 to each other.

The metal layer 123 may be a layer interposed between the first insulating layer 121 and the second insulating layer 122 and may prevent moisture and oxygen from being introduced from outside the case 120, and if the electrolyte is filled inside the case 120, the metal layer 123 may also prevent the electrolyte from leaking out. In some embodiments, the metal layer 123 may serve to maintain mechanical strength of the case 120. In some embodiments, the metal layer 123 may include aluminum, an aluminum alloy, iron, or an iron alloy.

The second insulating layer 122 may be provided as an outer surface of the case 120 to serve to alleviate mechanical and chemical impacts from external electronic devices. In some embodiments, the second insulating layer 122 may be provided on another surface of the metal layer 123 and may define an outer surface of the case 120. The second insulating layer 122 may include nylon, polyethylene terephthalate (PET), polybutylene terephthalate (PBT), or polybutylene naphthalate (PBN).

As the positive electrode active material, a compound capable of reversibly intercalating/deintercalating lithium (e.g., a lithiated intercalation compound) may be used. For example, at least one of a composite oxide of lithium and/or a metal selected from cobalt, manganese, nickel, and/or combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α}+(0.90≤a≤1.8, 0≤b≤0.5, 0≤c≤0.5, 0<α<2); LiₐNi_{1-b-c}Mn_{b}X_{c}O_{2-α}D_{α}+(0.90≤a≤1.8, 0≤b≤0.5, 0≤c≤0.5, 0<α<2); LiₐNi_{b}Co_{c}L¹_{d}GₑO₂ (0.90≤a≤1.8, 0<b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof, D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range from about 90 wt % to about 99.5 wt % on the basis of 100 wt % of the positive electrode active material layer, and the content of the binder and the conductive material is in a range from about 0.5 wt % to about 5 wt %, respectively, on the basis of 100 wt % of the positive electrode active material layer. The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x≤2), a Si-based alloy, or a combination thereof.

The silicon-carbon composite may be a composite of silicon and amorphous carbon. According to some embodiments, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer located on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

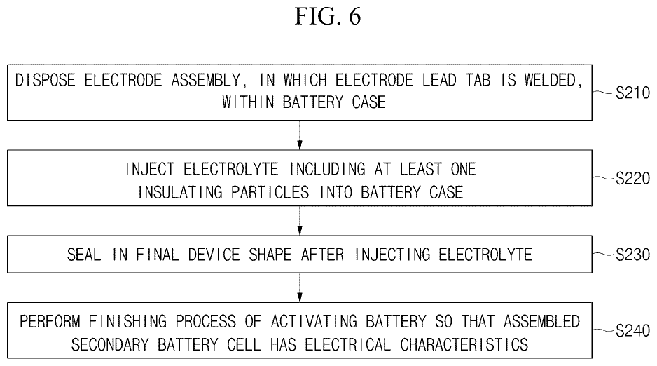

FIG. 6 illustrates a schematic flowchart of a method of manufacturing a secondary battery according to some embodiments of the present disclosure.

Referring to FIG. 6, a manufacturing method according to some embodiments may include a process S210 of disposing an electrode assembly in which an electrode lead tab is welded into a battery case; a process S220 of injecting an electrolyte, including at least one insulating particle, into the battery case; a process S230 of sealing the battery case into a final device shape after injecting the electrolyte; and a finishing process S240 of activating a battery so that an assembled secondary battery cell has electrical characteristics. However, this is only an exemplary manufacturing method

The electrolyte injection process S220 may include a process of preparing the electrolyte and a process of dispersing the insulating particles contained in the prepared electrolyte so as to be attached to a surface of a non-coated portion of the electrode assembly.

In the process of preparing the electrolyte, insulating particles within a standard electrolyte containing a non-aqueous organic solvent and a lithium salt may be dispersed. The term “standard electrolyte” may be used as a general term for electrolytes that are commonly used by those skilled in the art if manufacturing secondary batteries. To avoid duplicated explanations, characteristics (e.g., particle size of the insulating particles, etc.) of each component, which are not described in the manufacturing method, may follow characteristics of the components in the secondary battery described above.

In some embodiments, the insulating particles may be contained in the electrolyte at a concentration from about 5 wt % to about 20 wt %. If the insulating particles are contained at a concentration of less than about 5 wt %, insulating properties of the non-coated portion due to the dispersion of the insulating particles are not sufficiently achieved. If the particles are contained at a concentration of more than about 20 wt %, sufficient viscosity may not be achieved for the electrolyte to be impregnated into the electrode assembly.

To disperse the insulating particles within the electrolyte, the electrolyte containing the ceramic particles may be mixed at a stirring speed from about 150 rpm to about 250 rpm for about 1 minute to about 5 minutes. It has been experimentally confirmed that the ceramic particles may be appropriately dispersed in the electrolyte under the above stirring conditions.

Next, the electrolyte containing the ceramic particles dispersed therein will be injected into the battery case in which the electrode assembly is disposed. This process may be substantially the same as or similar to an electrolyte injection process according to related art, but a chromatographic phenomenon may be induced, where the insulating particles are separated from the electrolyte (during the process of injecting the electrolyte) and then are attached mainly to the non-coated portion.

Table 1 below shows a temperature and voltage change of the secondary battery according to a concentration of the insulating particles in the electrolyte. Comparative Example 1 shows results of applying the standard electrolyte (i.e., when the electrolyte does not contain the insulating particles), and Embodiments 1 and 2, respectively, show results of applying the electrolyte containing about 7.5 wt % and about 10 wt % of boehmite ceramic insulating particles in the standard electrolyte.

TABLE 1

| | Capacity min/ | | Voltage | Temperature |
|---|---|---|---|---|
| No. | Charging Voltage | Electrolyte | Change | Change |
| Comparative | 5,920 mAh/4.5 V | Standard | 0.63 V | 13.79° C. |
| Example 1 | | electrolyte | (4.45) | |
| | | (Boehmite | | |
| | | 0 wt %) | | |
| Embodiment | 5,920 mAh/4.5 V | Standard | 0.36 V | 4.92° C. |
| 1 | | electrolyte + | (4.46) | |
| | | Boehmite | | |
| | | 7.5 wt % | | |
| Embodiment | 5,920 mAh/4.5 V | Standard | 0.30 V | 5.86° C. |
| 2 | | electrolyte + | (4.46) | |
| | | Boehmite | | |
| | | 10 wt % | | |

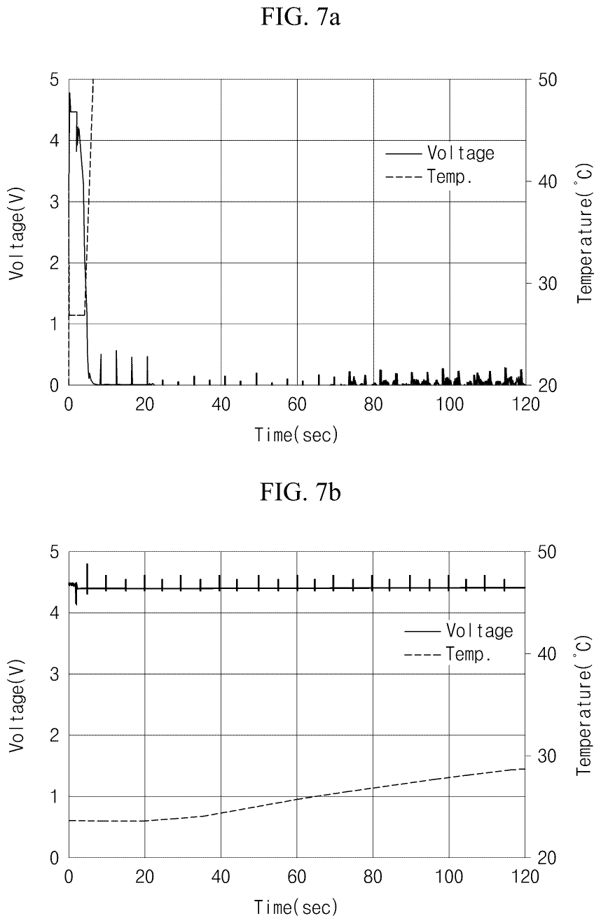

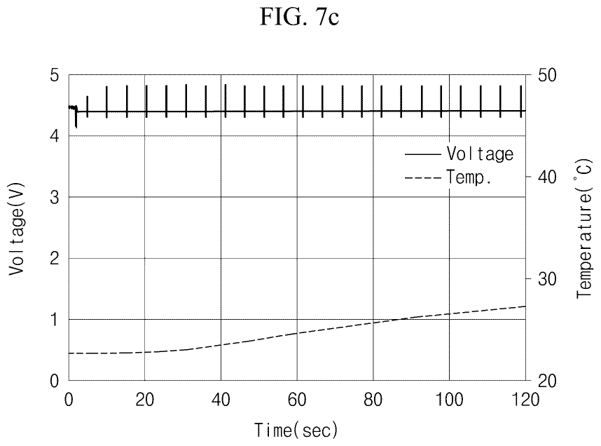

FIGS. 7a to 7c illustrate schematic graphs showing a temperature change with respect to time and a voltage change with respect to time for a secondary battery according to some embodiments of the present disclosure. Particularly, FIGS. 7a to 7c illustrate graphs for Comparative Example 1, Embodiment 1, and Embodiment 2 of Table 1, respectively.

As may be clearly seen from Table 1 above and FIGS. 7a to 7c, the ceramic particles in the electrolyte are naturally impregnated into the non-coated portion of the electrode assembly during the process of being injected into the battery case, and, thus, the insulating layer including the ceramic particles is formed well.

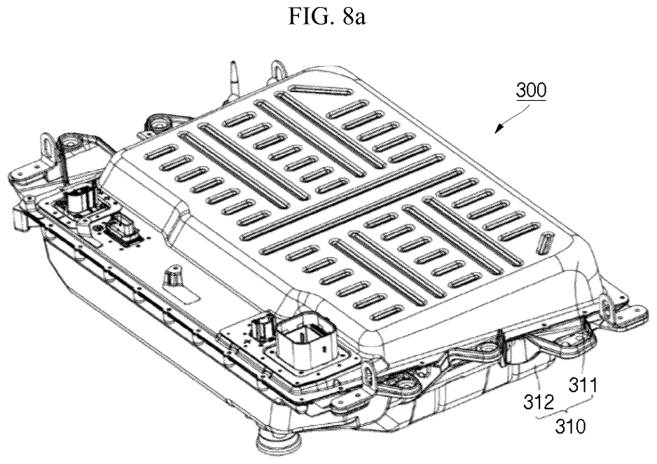

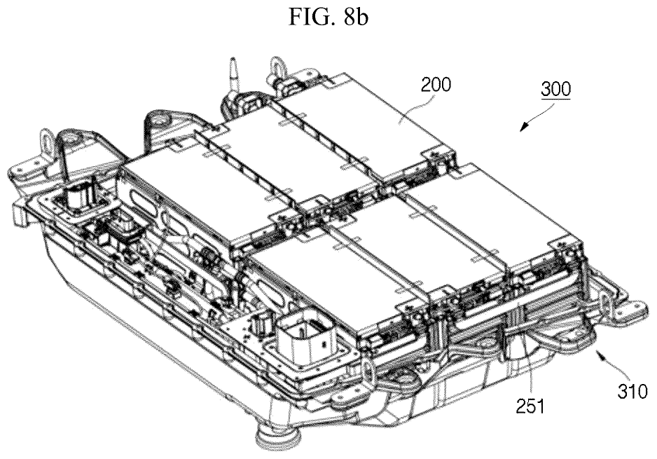

FIGS. 8a and 8b are perspective views showing a battery pack 300 including the secondary battery according to some embodiments. Referring to FIGS. 8a and 8b, the battery pack 300 may include a plurality of battery modules 200 and a housing 310 for accommodating the plurality of battery modules 200. For example, the housing 310 may include first and second housings and (i.e., a battery pack cover 311 and a pack frame 312) coupled in opposite directions through the plurality of battery modules 200. The plurality of battery modules 200 may be electrically connected to each other by using a bus bar 251, and the plurality of battery modules 200 may be electrically connected to each other in a series/parallel or series-parallel mixed method, thereby obtaining desired (e.g., required) electrical output. In the FIGS. 12 and 13, for convenience of illustration, parts such as bus bars, coolers, and external terminals for electrical connection of battery cells are omitted. In one or more embodiments, battery pack 300 may be mounted in a vehicle. The vehicle may be, for example, an electric vehicle, a hybrid vehicle, or a plug-in hybrid vehicle. The vehicle may include a four-wheeled vehicle or a two-wheeled vehicle.

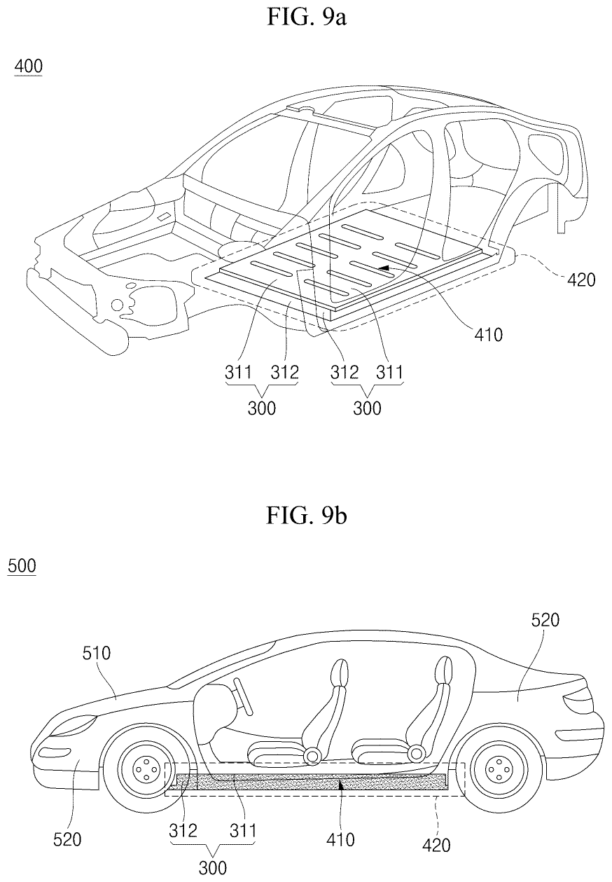

FIG. 9a illustrates a perspective view of a vehicle including an exemplary battery pack according to some embodiments of the present disclosure. FIG. 9b illustrates a side view of a vehicle including an exemplary battery pack according to some embodiments of the present disclosure. In FIG. 9a, a battery pack 300 may include a battery pack cover 311 (may correspond to the first housing above), which is a part of a vehicle underbody 410, and a pack frame 312 (may correspond to the second housing above) located under the vehicle underbody 410. The pack frame 312 and the battery pack cover 311 may be integrally formed with a vehicle floor 420. The vehicle underbody 410 separates the inside and outside of a vehicle, and the pack frame 312 may be located outside the vehicle.

In FIG. 9b, a vehicle 500 may be formed by combining additional parts, such as a hood 510 in front of the vehicle and fenders 520 respectively located in the front and rear of the vehicle to a vehicle body parts 400. The vehicle 500 may further include a vehicle floor 420, which is one of the vehicle body parts 400 including the battery pack 300 including the pack frame 312 and the battery pack cover 311.

According to the present disclosure, if an insulating layer is applied on a surface of an area of a non-coated portion of a secondary battery to which an electrode active material is not applied, the insulating layer may be introduced without performing a separate coating process, improving an efficiency for manufacturing a secondary battery.

In addition, a short-circuit of the secondary battery may be prevented by an insulating effect on the surface of the non-coated portion of the secondary battery.

However, aspects and features of the present disclosure are not limited to those described above, and other aspects and features not mentioned will be clearly understood by a person skilled in the art from the detailed description, described above.

Although the present disclosure has been described above via examples and drawings, the present disclosure is not limited thereto, and various modifications and variations may be made by those skilled in the art in the technical field to which the present disclosure belongs within the technical idea of the present disclosure.

What is claimed is:

1. A secondary battery comprising:
an electrode assembly comprising:
a first electrode plate comprising:
a first electrode active material layer on at least one surface thereof; and
a first non-coated portion having a surface accepting an insulating material;
a second electrode plate comprising:
a second electrode active material layer on at least one surface thereof; and
a second non-coated portion having a surface accepting an insulating material; and
a separator disposed between the first electrode plate and the second electrode plate;
an electrolyte; and
a battery case in which the electrode assembly and the electrolyte are disposed,
wherein an insulating coating layer comprising insulating particles is disposed on at least one of the first non-coated portion, of which a first electrode active material is not applied on the first electrode plate, or the second non-coated portion, of which a second electrode active material is not applied on the second electrode plate,
wherein the insulating particles of the insulating coating layer are provided to the first non-coated portion or to the second non-coated portion by attaching insulating particles of the electrolyte to the surface of the first non-coated portion or the second non-coated portion.

2. The secondary battery as claimed in claim 1, wherein the insulating particles of the insulating coating layer are a same type of particle as at least one insulating particle of the insulating particles of the electrolyte.

3. The secondary battery as claimed in claim 1, wherein the insulating particles of the insulating coating layer are ceramic particles.

4. The secondary battery as claimed in claim 3, wherein the ceramic particles comprise boehmite.

5. The secondary battery as claimed in claim 1, wherein the insulating particles of the insulating coating layer are non-uniformly dispersed on the insulating coating layer.

6. The secondary battery as claimed in claim 1, wherein a particle size of each of the insulating particles of the insulating coating layer is from about 150 nm to about 200 nm based on D50.

7. The secondary battery as claimed in claim 1, wherein insulating particles that are identical to insulating particles disposed on the insulating coating layer are dispersed on a surface of at least one of the first electrode active material layer or the second electrode active material layer of the electrode assembly.

8. The secondary battery as claimed in claim 7, wherein a minimum distance between the insulating particles disposed on the insulating coating layer is narrower than a minimum distance between the insulating particles disposed on at least one of the first electrode active material layer or the second electrode active material layer.

9. The secondary battery as claimed in claim 7, wherein a density at which the insulating particles disposed on the insulating coating layer are dispersed is greater than a density at which the insulating particles disposed on at least one of the first electrode active material layer or the second electrode active material layer are dispersed.

10. The secondary battery as claimed in claim 1, wherein the battery case includes a first case, a second case bonded to the first case, and a recess configured to accept the electrode assembly, and
wherein the secondary battery is configured as a pouch-type secondary battery.

11. A method of manufacturing a secondary battery, the method comprising:
providing an electrode assembly, in which an electrode lead tab is welded inside a battery case; and
injecting an electrolyte, having or more insulating particles, into the battery case,
wherein the injecting comprises dispersing the insulating particles of the electrolyte so that the one or more insulating particles are attached on a surface of a first non-coated portion on which a first electrode active material layer is not formed and on a surface of a second non-coated portion on which a second electrode active material layer is not formed.

12. The method as claimed in claim 11, further comprising dispersing and attaching the one or more insulating particles within the electrolyte on the first non-coated portion and the second non-coated portion via a chromatographic phenomenon.

13. The method as claimed in claim 11, wherein the injecting further comprises dispersing one or more ceramic particles as the one or more insulating particles within the electrolyte.

14. The method as claimed in claim 11, wherein the injecting further comprises dispersing insulating particles having a concentration from about 5 wt % to about 20 wt % within the electrolyte.

15. The method as claimed in claim 11, wherein the dispersing comprises dispersing ceramic particles within the electrolyte before injecting the electrolyte into the battery case.

16. The method as claimed in claim 15, wherein the dispersing the ceramic particles comprises mixing the electrolyte at a speed of about 150 rpm to about 250 rpm for about 1 minute to about 5 minutes.

17. The method as claimed in claim 11, further comprising dispersing the one or more insulating particles on a surface of at least one of the first electrode active material layer or the second electrode active material layer, so that the insulating particles of the electrolyte are attached on surfaces of the first non-coated portion or the second non-coated portion within the electrode assembly.

18. The method as claimed in claim 17, further comprising disposing the one or more insulating particles on a surface of the first non-coated portion and a surface of the second non-coated portion at a greater density than a density of which the insulating particles are dispersed on a surface of at least one of the first electrode active material layer or the second electrode active material layer.
